(19) United States
(12) Patent Application Publication
(10) Pub. No.: US 2020/0005117 A1
(43) Pub. Date: Jan. 2, 2020

(54) ARTIFICIAL INTELLIGENCE ASSISTED CONTENT AUTHORING FOR AUTOMATED AGENTS

(71) Applicant: Microsoft Technology Licensing, LLC, Redmond, WA (US)

(72) Inventors: Changhong Yuan, Sammamish, WA (US); Eslam Abdel-Reheem, Sammamish, WA (US); Omar Abouelkhir, Redmond, WA (US); Xi Yun, Redmond, WA (US); Mingyu Wang, Sammamish, WA (US); Jiantao Sun, Bellevue, WA (US); Zheng Chen, Bellevue, WA (US); Yi-Min Wang, Redmond, WA (US); Jianwen Zhang, Sammamish, WA (US); Wei Xie, Redmond, WA (US); Liaoyuan Ning, Sammamish, WA (US); Jiayuan Huang, Bellevue, WA (US)

(21) Appl. No.: 16/022,317

(22) Filed: Jun. 28, 2018

(51) Int. Cl. G06N 3/00; G06F 17/30; G06N 7/00; G06N 99/00

(52) U.S. Cl. CPC G06N 3/006; G06N 99/005; G06N 7/005; G06F 17/30958

(57) ABSTRACT

Systems and devices to perform content authoring and establish conversation models for automated agents such as chatbots and virtual assistants are disclosed. In an example, operations for content authoring, to produce a conversation model, include: identifying respective intents from conversation segments in an unstructured data source; generating a knowledge graph of the conversation model to organize the identified intents; linking the intents in the knowledge graph to properties of the respective conversations, for properties used to guide a subject conversation with the conversation model; and outputting the conversation model, to be usable with the automated agent to conduct the subject conversation with a human user. In further examples, the operations include defining trigger phrases, solutions, and constraints corresponding to the respective intents, such that subsequent use of the knowledge graph by the conversation model directs the subject conversation based on an intent expressed in the subject conversation.

### RELATED APPLICATIONS

This application is related to U.S. patent application Ser. No. ______ titled “KNOWLEDGE-DRIVEN DIALOG SUPPORT CONVERSATION SYSTEM” and filed on Jun. ______, 2018, U.S. patent application Ser. No. ______ titled “OFFTRACK VIRTUAL AGENT INTERACTION SESSION DETECTION” and filed on June 2018, U.S. patent application Ser. No. ______ titled “CONTEXT-AWARE OPTION SELECTION IN VIRTUAL AGENT” and filed on Jun. ______, 2018, and U.S. patent application Ser. No. ______ titled “VISUALIZATION OF USER INTENT IN VIRTUAL AGENT INTERACTION” and filed on Jun. ______, 2018, the contents of each of which is incorporated herein by reference in their entirety

### BACKGROUND

Automated agents such as chatbots, avatars, and voice assistants, also known as “virtual” agents, play an increasing role in human-to-computer interactions. As the sophistication and types of access to these automated agents has increased, so has the type of tasks that automated agents are being used with. One common form of virtual agent includes an automated agent that is designed to conduct a back-and-forth conversation with a human user, similar to a phone call or chat session. The conversation with the human user may have a purpose, such as to provide a user with a solution to a problem they are experiencing, and to provide some specific advice or perform an action in response to the conversation content.

One area in which automated virtual agents are expected to be increasingly deployed is in the area of support tasks traditionally performed by humans at call centers, such as customer support for product sales and technical support issues. Many forms of current virtual agents, however, often fail to meet user expectations or solve problems, due to the large amount of possible questions, answers, responses, and types of user interactions that may be encountered for such support tasks.

Existing deployments of automated agents for customer support may require many manual steps and processing actions to create a suitable data set for agent-to-human interactions. For instance, one conventional approach involves an enterprise providing knowledge base documents or webpages in formats upon which the automated agent can run some type of keyword or natural language search. However, the use of searches to answer questions is often ineffective for many deployments, because the automated agent is limited to use of the specific keywords and phrasing that a particular human uses. Another conventional approach involves the manual creation of specific chatbot dialog questions and answers. However, if the user asks a question or provides an answer that is not expected, the chatbot is unlikely to be able to assist. As a result, under either approach, a large amount of time and effort must be expended by human editors to establish, curate, and expand the data set used by the automated agent, even as many customer questions or issues are not fully resolved.

### SUMMARY

Various details for the embodiments of the inventive subject matter are provided in the accompanying drawings and in the detailed description text below. It will be understood that the following section provides summarized examples of some of these embodiments.

Embodiments described herein generally relate to automated and computer-based techniques, to perform content authoring for chatbots and other types of automated agents. In particular, the following techniques utilize artificial intelligence and other technological implementations for the creation, identification, population, maintenance, and curation of a knowledge set usable in virtual agent conversations. In an example, embodiments may include operations to produce a conversation model for use with an automated agent, with operations comprising: identifying respective intents from conversation segments in an unstructured data source; generating a knowledge graph of the conversation model to organize the identified intents, the knowledge graph structured to associate respective conversations with the respective intents; linking the respective intents in the knowledge graph to properties of the respective conversations, with the properties used to guide a subject conversation with the conversation model, such as for properties that include trigger phrases, solutions, and constraints corresponding to the respective intents; and outputting the conversation model, the conversation model usable with the automated agent to conduct the subject conversation with a human user, such that subsequent use of the knowledge graph by the conversation model directs the subject conversation based on an intent expressed in the subject conversation.

In a further example, the embodiments may perform operations of extracting the conversation segments from the unstructured data source, such that the conversation segments are extracted from one or more of: human-agent voice conversation transcripts, human-agent text chat logs, human-authored knowledge base information, human-authored web page content, or human-authored documentation. In still further examples, the embodiments may perform operations including applying a machine learning model to respective segments of the conversation data, such as for a machine learning model adapted to identify the intent and a conversation content type from the respective segments of the conversation data.

In a further example, the conversation model is designed to conduct the subject conversation in a technical support scenario with the human user, to handle an intent expressed in the subject conversation that relates to one or more support issues in the technical support scenario. This may allow handling of solutions that relate to one or more support solutions in the technical support scenario, such as for constraints that relate to properties of a product or service involved with the support issues. These constraints may further relate to a plurality of properties for a product, such as for one or more of: a product instance, a product type, a product version, a product release, a product feature, or a product use case.

An embodiment discussed herein includes a computing device including processing hardware (e.g., a processor) and memory hardware (e.g., a storage device or volatile memory) including instructions embodied thereon, such that the instructions, which when executed by the processing hardware, cause the computing device to implement, perform, or coordinate the electronic operations. Another embodiment discussed herein includes a computer program product, such as may be embodied by a machine-readable medium or other storage device, which provides the instructions to implement, perform, or coordinate the electronic operations. Another embodiment discussed herein includes a method operable on processing hardware of the computing device, to implement, perform, or coordinate the electronic operations.

As discussed herein, the logic, commands, or instructions that implement aspects of the electronic operations described above, may be performed at a client computing system, a server computing system, or a distributed or networked system (and systems), including any number of form factors for the system such as desktop or notebook personal computers, mobile devices such as tablets, netbooks, and smartphones, client terminals, virtualized and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described above, or other aspects depicted in the accompanying drawings and detailed description below.

This summary section is provided to introduce aspects of the inventive subject matter in a simplified form, with further explanation of the inventive subject matter following in the text of the detailed description. This summary section is not intended to identify essential or required features of the claimed subject matter, and the particular combination and order of elements listed this summary section is not intended to provide limitation to the elements of the claimed subject matter.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts a diagram illustrating a system architecture providing enhanced conversation capabilities in a virtual agent, according to an example.

FIG. 2 depicts an operational flow diagram illustrating a deployment of a knowledge set used in a virtual agent, according to an example.

FIG. 3 depicts a flowchart that illustrates operations for an assisted authoring process, for establishing a knowledge set used in a virtual agent, according to an example

FIG. 4 depicts a diagram that illustrates operations for intent discovery, used with establishing a knowledge set used in a virtual agent, according to an example

FIG. 5 depicts a diagram that illustrates operations for building a knowledge graph, used with establishing a knowledge set used in a virtual agent, according to an example.

FIG. 6 depicts a diagram that illustrates operations for use of an authoring solution, used with establishing conversations of a virtual agent from a knowledge service, according to an example.

FIGS. 7 and 8 depict graphical user interfaces that illustrate suggested solutions generated with the automated authoring techniques discussed herein, according to an example.

FIG. 9 depicts a graphical user interface that illustrates suggested questions generated with the automated authoring techniques discussed herein, according to an example.

FIG. 10 depicts a flowchart of a method for automated content authoring, used with establishing a knowledge set used in a virtual agent, according to an example

FIG. 11 depicts a block diagram of hardware and functional components of a computing system to implement operations for automated authoring, used with establishing a knowledge set used in a virtual agent, according to an example.

### DETAILED DESCRIPTION

In the following description, methods, configurations, and related apparatuses are disclosed for various aspects of content authoring and management used for virtual agent interactions. These techniques include example implementations of artificial intelligence (AI) models that can be used to identify a knowledge set for a virtual agent from an enterprise's unstructured data, such as from support documents, webpages, case notes, historical chat transcripts, and the like. The techniques may further provide recommendations of intents, trigger phrases, solutions, questions, and accompanying answers, to enable editors to more efficiently and accurately identify and author knowledge data for virtual agent deployments.

The content used in interactions is crucial for many human-facing automated agents. In particular, the scope and quality of content must be sufficient for technical support chat bots and other agents to efficiently and correctly solve end-users' problems. However, with existing systems, the process of content creation and curation for technical support purposes is time-consuming, highly dependent on skilled editors having domain knowledge, and produces ad-hoc results with inconsistent content quality. In addition, many technical challenges are involved to organize, authorize, track, store, and update content by both the agent and human editors, especially as content or issues change over time. Some studies have indicated that, on average, around one third of unsuccessful conversations with automated agents are caused by incomplete or wrong content.

The presently described AI-assisted content authoring techniques provide an effective and efficient framework to create, organize, and deliver content in a technical support scenario and a variety of other agent scenarios. The present authoring techniques include the use of knowledge mining workflows, and the organization of knowledge graph and intent data structures, which are suitable for consumption by a virtual agent in a knowledge information service. For example, in the context of a technical support virtual agent, the present AI-assisted content authoring techniques may involve: identifying content for a particular support issue (an “intent”); developing an intent list to identify solutions for multiple types of intents; and identifying and approving suitable questions and answers to use in an interaction.

In an example, a technique for generating content for an automated agent includes use of AI-assisted techniques and data processing to mine, recommend, and deploy candidate content from un-structured or semi-structured data. First, an initial set of unstructured data such as chat transcripts may be labeled and used to train a machine learning model on a structure. Second, the trained model may be reapplied to a larger set of unstructured data to produce candidate intents. Third, the candidate intents may be linked and organized in a knowledge graph, to link intents to other characteristics. Finally, the support knowledge graph, may be used to provide a number of recommendations when authoring new content, revising existing content, validating or verifying content details, or the like.

The techniques discussed herein may be applied to a variety of types of unstructured input data, including human-agent transcripts, web page contents, documentation and user manuals text, knowledge base articles, internet data services, or the like. Thus, in contrast to existing approaches that require extensive setup or a large amount of pre-scripted data, and constraints to be manually customized to the type and origin of data, the presently disclosed techniques provide a framework which automates many aspects of content authoring and management. As non-limiting examples, the techniques may be used to provide recommendations for content authoring in the following contexts: given an intent, identify and recommend ranked knowledge base or web page documents; given an intent, recommend ranked and grouped agent chat solutions; given an intent, recommend ranked and grouped questions and their responses; given a knowledge base or chat transcript source, recommend ranked and grouped questions and their responses; given a knowledge base or chat transcript source, recommend the existent properties related to authoring; or, given a knowledge base or chat transcript source, recommend entities. Other types of recommendations and results are also illustrated in the following paragraphs.

The techniques discussed herein may produce an enhanced form of data analysis with an accompanying benefit in the technical processes performed in computer and information systems, and computer-human interfaces. These benefits may include: improved responsiveness and interaction sequences involving automated agents; improved accuracy and precision of information retrieval and presentation activities; increased speed for the analysis of data records; fewer data transactions and agent interactions, resulting in savings of processing, network, and memory resources; and data organizational benefits as unstructured data is more accurately cataloged, organized, and delivered. Such benefits may be achieved with accompanying improvements in technical operations in the computer system itself (including improved operations with processor, memory, bandwidth, storage, or other computing system resources). Further, such benefits may also be used to initiate or trigger other dynamic computer activities, leading to further technical benefits and improvements with electronic operational systems.

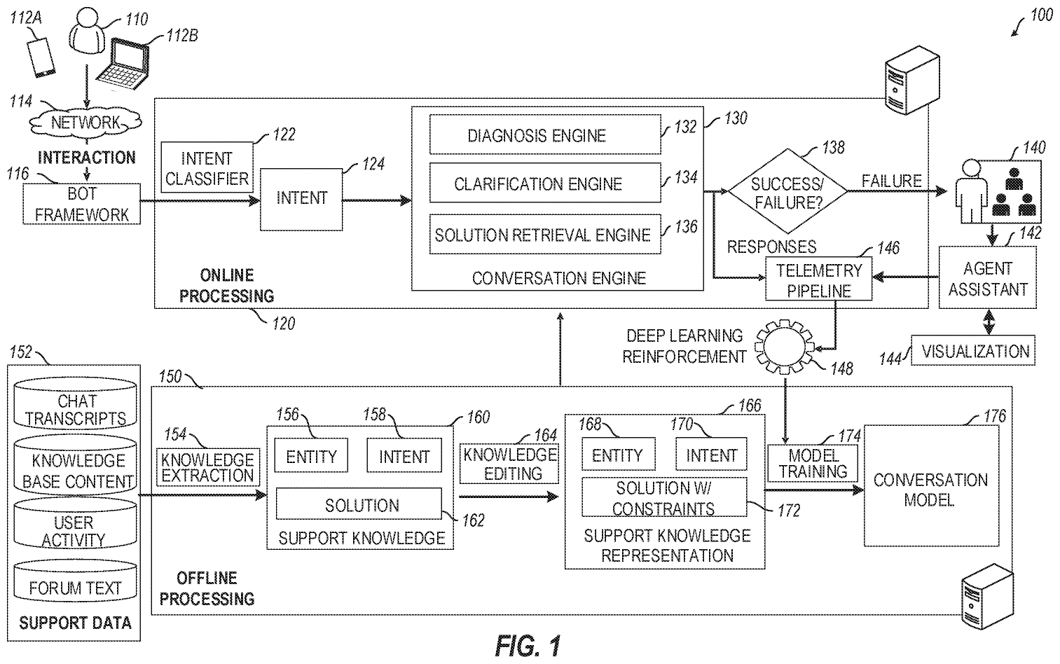

FIG. 1 is a diagram illustrating an example system architecture 100 providing enhanced conversation capabilities in a virtual agent. The present techniques for AI authoring may be employed at a number of different locations in the system architecture 100, including, knowledge extraction engine 154, knowledge editing process 164, and model training 174 functionality, and as part of using or establishing support data 152, candidate support knowledge set 160, support knowledge representation data set 166, conversation model 176, and other aspects of data used in offline processing system 150 or online processing system 120, as discussed in the following paragraphs. As used herein, such “online” processing generally refers to processing capabilities to provide the user an experience while online (e.g., in real time, while actively using the automated agent or the computing device); whereas such “offline” processing generally refers to processing capabilities to provide the user with data and capabilities at a later time (e.g., not in real time). Accordingly, online versus offline processing may be distinguishable in time, resources, and applicable workflows.

The system architecture 100 illustrates an example scenario in which a human user 110 conducts an interaction with a virtual agent online processing system 120. The human user 110 may directly or indirectly conduct the interaction via an electronic input/output device, such as within an interface device provided by a mobile device 112A or a personal computing device 112B. The human-to-agent interaction may take the form of one or more of text (e.g., a chat session), graphics (e.g., a video conference), or audio (e.g., a voice conversation). Other forms of electronic devices (e.g., smart speakers, wearables, etc.) may provide an interface for the human-to-agent interaction or related content. The interaction that is captured and output via the device(s) 112A, 112B, may be communicated to a bot framework 116 via a network. For instance, the bot framework 116 may provide a standardized interface in which a conversation can be carried out between the virtual agent and the human user 110 (such as in a textual chat bot interface). The bot framework 116 may also enable conversations to occur through information services and user interfaces exposed by search engines, operating systems, software applications, webpages, and the like.

The conversation input and output are provided to and from the virtual agent online processing system 120, and conversation content is parsed and output with the system 120 through the use of a conversation engine 130. The conversation engine 130 may include components that assist in identifying, extracting, outputting, and directing the human-agent conversation and related conversation content. The conversation engine 130 uses its engines 132, 134, 136 to process user input and decides what solutions constraints are matched or violated. Such processing is help decide the final bot response: to ask questions or deliver solutions, and identify which question/solution to deliver.

As depicted, the conversation engine 130 includes: a diagnosis engine 132 used to extract structured data from user inputs (such as entity, intent, and other properties) and assist with the selection of a diagnosis (e.g., a problem identification); a clarification engine 134 used to deliver questions to ask, to obtain additional information from incomplete, ambiguous, or unclear user conversation inputs, or to determine how to respond to a human user after receiving an unexpected response from the human user; and a solution retrieval engine 136 used to rank and decide candidate solutions, and select and output a particular candidate solution or sets of candidate solutions, as part of a technical support conversation. Thus, in the operation of a typical human-agent interaction via a chatbot, various human-agent text is exchanged between the bot framework 116 and the conversation engine 130.

In some examples, the conversation engine 130 selects a particular solution with the solution retrieval engine 136, or selects a clarification statement with the clarification engine 134, or selects a particular diagnosis with the diagnosis engine, based on real-time scoring relative to the current intent 124 and a current state of the conversation. This scoring may be used to track a likelihood of a particular solution and a likelihood of a particular diagnosis, at any given time. For instance, the scoring may be based multiple factors such as, (a) measuring the similarity between the constraints or previous history of solution and diagnosis with current intent, conversation and context; and (b) the popularity of solution or diagnosis based on history data.

The virtual agent online processing system 120 involves the use of intent processing, as conversational input received via the bot framework 116 is classified into an intent 124 using an intent classifier 122. As discussed herein, an intent refers to a specific type of issue, task, or problem to be resolved in a conversation, such as an intent to resolve an account sign-in problem, or an intent to reset a password, or an intent to cancel a subscription, or the like. For instance, as part of the human-agent interaction in a chatbot, text captured by the bot framework 116 is provided to the intent classifier 122. The intent classifier 122 identifies at least one intent 124 to guide the conversation and the operations of the conversation engine 130. The intent can be used to identify the dialog script that defines the conversation flow, as solutions and discussion in the conversation attempts to address the identified intent. The conversation engine 130 provides responses and other content according to a knowledge set used in a conversation model, such as a conversation model 176 that can be developed using an offline processing technique discussed below.

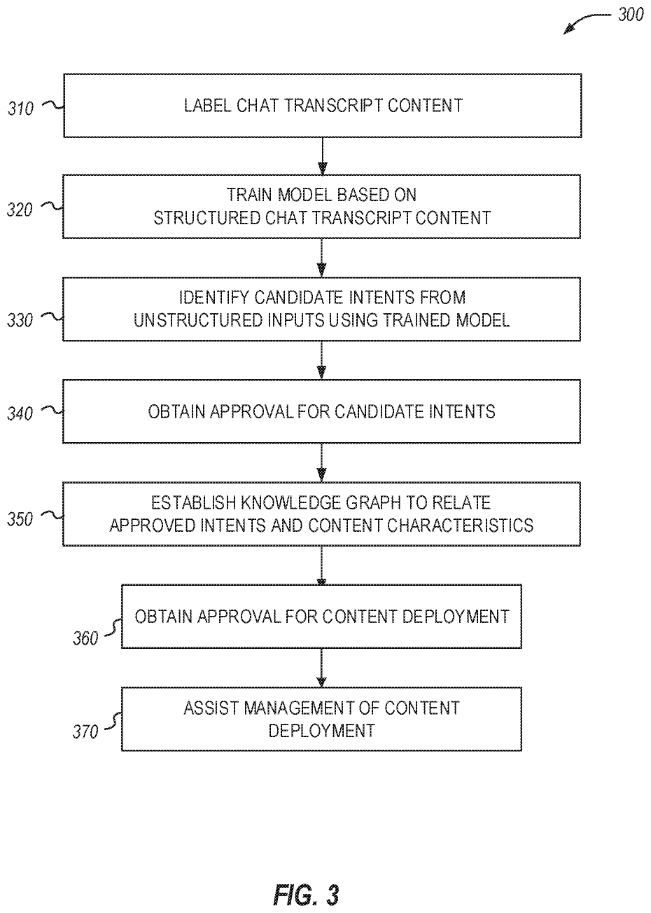

The virtual agent online processing system 120 may be integrated with feedback and assistance mechanisms, to address unexpected scenarios and to improve the function of the virtual agent for subsequent operations. For instance, if the conversation engine 130 is not able to guide the human user 110 to a particular solution, an evaluation 138 may be performed to escalate the interaction session to a team of human agents 140 who can provide human agent assistance 142. The human agent assistance 142 may be integrated with aspects of visualization 144, such as to identify conversation workflow issues or understand how an intent is linked to a large or small number of proposed solutions. Additionally, such visualization may be used as part of offline processing and training, such as with the techniques discussed with reference to FIGS. 3 to 10.

The conversation model employed by the conversation engine 130 may be developed through use of a virtual agent offline processing system 150. The conversation model 176 may include any number of questions, answers, or constraints, as part of generating conversation data. Specifically, FIG. 1 illustrates the generation of a conversation model 176 as part of a support conversation knowledge scenario, where a human-virtual agent conversation is used for satisfying an intent with a customer support purpose. The purpose may include technical issue assistance, requesting an action be performed, or another inquiry or command for assistance.

The virtual agent offline processing system 150 may generate the conversation model 176 from a variety of support data 152, such as chat transcripts, knowledge base content, user activity, web page text (e.g., from web page forums), and other forms of unstructured content. This support data 152 is provided to a knowledge extraction engine 154, which produces a candidate support knowledge set 160. The candidate support knowledge set 160 links each candidate solution 162 with an entity 156 and an intent 158. Further details on the knowledge extraction engine 154 and the creation of a candidate support knowledge set 160 are provided in relation to the AI authoring techniques of FIGS. 3 to 10. Although the present examples are provided with reference to support data in a customer service context, it will be understood that the conversation model 176 may be produced from other types of input data and other types of data sources.

The candidate support knowledge set 160 is further processed as part of a knowledge editing process 164, which is used to produce a support knowledge representation data set 166. The support knowledge representation data set 166 also links each identified solution 172 with at least one entity 168 and at least one intent 170, and defines the identified solution 172 with constraints. For example, a human editor may define constraints such as conditions or requirements for the applicability of a particular intent or solution; such constraints may also be developed as part of automated, computer-assisted, or human-controlled techniques in the offline processing (such as with the model training 174 or the knowledge editing process 164).

In an example, editors and business entities may utilize the knowledge editing process 164 to review and approve business knowledge and solution constraints, to ensure that the information used by the agent is correct and will result in correct responses. As an example of business knowledge, consider a customer support bot designed for a business; the business knowledge may include a specific return policy, such as for a retail store which has different return policies for products purchased from local store and online. As an example of solution constraints, consider a scenario where business owners review the scope of customer requests handled by the bot, to review the list of intents and exclude some of them from being handled by the bot; such a constraint could prevent a customer from requesting cash back (or conduct some other unauthorized action) in connection with a promotional program.

Also in an example, an entity may be a keyword or other tracked value that impacts the flow of the conversation. For example, if an end user intent is, “printer is not working”, a virtual agent may ask for a printer model and operating system to receive example replies such as “S7135” and “Windows”. In this scenario, “printer”, “S7135” and “Windows” are entities. As an example, an intent may represent the categorization of users' questions, issues, or things to do. For example, an intent may be in the form of, “Windows 10 upgrade issue”, “How do I update my credit card?”, or the like. As an example, a solution may include or define a concrete descriptionto answer or solve a users' question or issue. For example, “To upgrade to Windows 10, please follow the following steps: 1) backup your data, . . . 2) Download the installer, . . . , 3) Provide installation information, . . . ”, etc.

Based on inputs provided by the candidate support knowledge set 160, model training 174 may be used to generate the resulting conversation model 176. This conversation model 176 may be deployed in the conversation engine 130, for example, and used in the online processing system 120. The various responses received in the conversation of the online processing may also be used as part of a telemetry pipeline 146, which provides a deep learning reinforcement 148 of the responses and response outcomes in the conversation model 176. Accordingly, in addition to the offline training, the reinforcement 148 may provide an online-responsive training mechanism for further updating and improvement of the conversation model 176.

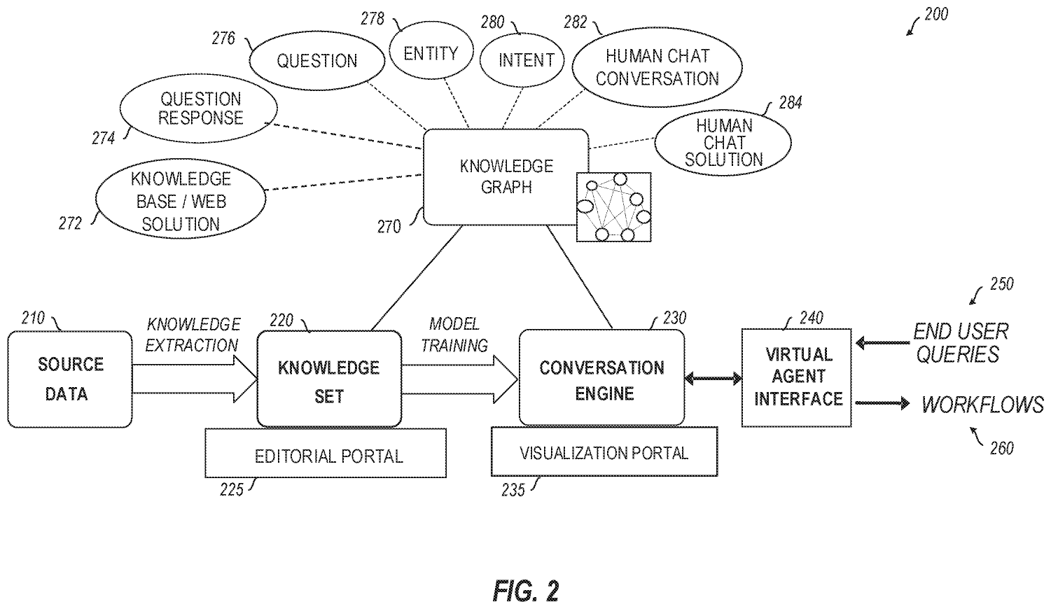

FIG. 2 is an operational flow diagram illustrating an example deployment 200 of a knowledge set used in a virtual agent, such as with use of the conversation model 176 and online/offline processing depicted in FIG. 1. The operational deployment 200 depicts an operational sequence 210, 220, 230, 240, 250, 260 involving the creation and use of organized knowledge, and a data organization 270, 272, 274, 276, 278, 280, 282, 284, involving the creation of a data structure, termed as a knowledge graph 270, which is used to organize concepts.

In an example, source data 210 is unstructured data from a variety of sources (such as the previously described support data). A knowledge extraction process is operated on the source data 210 to produce an organized knowledge set 220. An editorial portal 225 may be used to allow the editing, selection, activation, or removal of particular knowledge data items by an editor, administrator, or other personnel. The data in the knowledge set 220 for a variety of associated issues or topics (sometimes called intents), such as support topics, is organized into a knowledge graph 270 as discussed below.

The knowledge set 220 is applied with model training, to enable a conversation engine 230 to operate with a conversation model (e.g., conversation model 176 referenced above). The conversation engine 230 dynamically selects appropriate inquiries, responses, and replies for the conversation with the human user, as the conversation engine 230 uses information on various topics stored in the knowledge graph 270. A visualization engine 235 may be used to allow visualization of conversations, inputs, outcomes, and other aspects of use of the conversation engine 230.

The virtual agent interface 240 is used to operate the conversation model in a human-agent input-output setting (also referred to as an interaction session). While the virtual agent interface 240 may be designed to perform a number of interaction outputs beyond targeted conversation model questions, the virtual agent interface 240 may specifically use the conversation engine 230 to receive and respond to end user queries 250 or statements (including answers, clarification questions, observations, etc.) from human users. The virtual agent interface 240 then may dynamically enact or control workflows 260 which are used to guide and control the conversation content and characteristics.

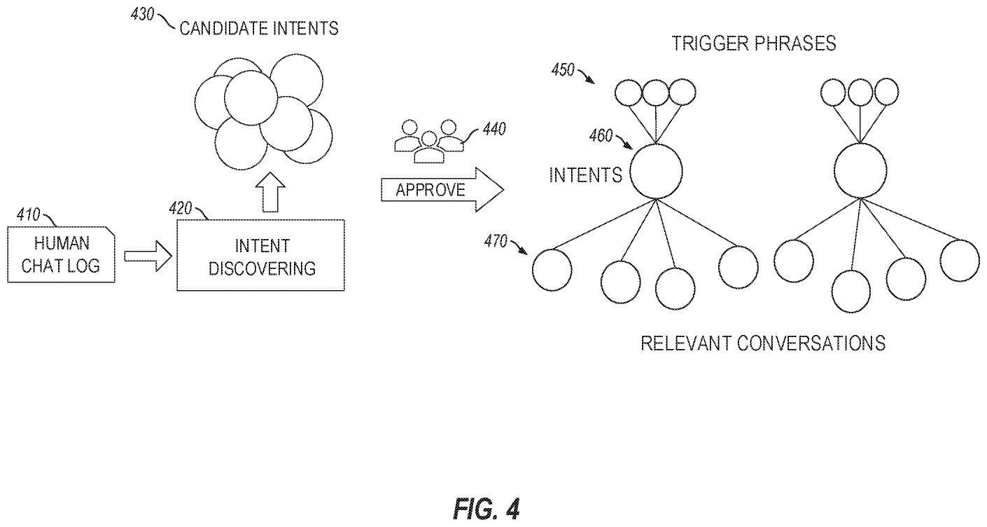

The knowledge graph 270 is shown as including linking to a number of data properties and attributes, relating to applicable content used in the conversation model 176. Such linking may involve relationships maintained among: knowledge content data 272, such as embodied by data from a knowledge base or web solution source; question response data 274, such as natural language responses to human questions; question data 276, such as embodied by natural language inquiries to a human; entity data 278, such as embodied by properties which tie specific actions or information to specific concepts in a conversation; intent data 280, such as embodied by properties which indicate a particular problem or issue or subject of the conversation; human chat conversation data 282, such as embodied by rules and properties which control how a conversation is performed; and human chat solution data 284, such as embodied by rules and properties which control how a solution is offered and provided in a conversation. A more specific illustration of how the data values 272-284 are identified and linked to each other in a knowledge graph is provided in FIG. 4 below.

In an example, the operational deployment 200 may include multiple rounds of iterative knowledge mining, editing, and learning processing. For instance, iterative knowledge mining may be used to perform intent discovery in a workflow after chat transcript data is labeled (with human and machine efforts) into structured data. This workflow may first involve use of a machine to automatically group phrases labeled in a “problem” category, extract candidate phrases, and ultimately recommend intents. Human editors can then review the grouping results, make changes to the phrase/intent relationship, and change intent names or content based on machine recommendation results. The changes made by human editors can then be taken as input into the workflow, to perform a second round of processing in order to improve the quality of discovered intent. Additionally, although machine-based processes may be used to identify and establish many values in the operational deployment 200, the changes made by the human edits can be respected such that machines only make recommendations for data not covered by human editors. This process will repeat until the quality of intent discovery is sufficient. Accordingly, the operational deployment 200 may utilize automated and AI techniques to assist human editors to perform tasks and work and to make decisions, within a variety of authoring and content management aspects.

FIG. 3 is a flowchart 300 that illustrates example operations for an assisted authoring process, for establishing a knowledge set used in a conversation model by a virtual agent. These operations are expanded upon by the accompanying operations and configurations illustrated in FIGS. 4 to 11. For instance, the operations in the flowchart 300 may represent aspects of the offline processing, knowledge extraction, and model training, discussed in FIGS. 1 and 2, as applied to a customer service chat setting.

In operation 310, operations are performed to obtain and label an initial set of chat transcript content. For example, a sample of conversation data (e.g., a set of thousands of conversations, selected from millions of conversation statements) may be evaluated and labeled, such as by human-initiated (manual) labeling. This labeling may identify statements or portions of statements with labels that indicate respective questions, answers, followup questions, followup answers, issues, or the like. Then, in operation 320, operations are performed to train a machine learning model using the sample of labeled conversation data, which provides structured content for training and classification.

The trained machine learning model may be utilized, in operation 330, to identify candidate intents from the larger set of (unstructured) conversation data. The candidate intents may be provided to a human user (e.g., administrator, editor, or curator) to receive approval, in operation 340. A knowledge graph for the conversation model is then established to relate approved intents with content characteristics, in operation 350. For instance, various trigger prompts (such as “I can't log into my computer”) or queries (such as “How do I unlock my computer”) may be tied to certain intents (“Reset Password”) of a conversation.

Finally, after further review and revision, the authoring process is used to obtain approval for a content deployment via the conversation model, in operation 360. The authoring process may be followed by procedures to assist the management of a content deployment, in operation 370, such as through editing, revision, and changes to accompanying constraints and conditions.

In an example, the machine learning model in operation 320 and 330 is a conditional random field (CRF) classifier. A CRF classifier is a type of discriminative undirected probabilistic graphical model and is a kind of sequence model that is usable for structured prediction. The CRF classifier may operate, for example, to classify the content type of chat conversation utterances to defined categories such as “problem”, “clarification question”, “clarification answer”, “solution”, or like categories. Such a classifier may be trained by few thousands of manually classified conversations, and then used to automatically classify the utterances of millions (or more) of raw conversations to the same content types. Additionally, a CRF classifier can take a context into account, to produce better classification performance. For example, in the chat log conversation, an utterance tagged as “Clarification Answer” often follows an utterance tagged as “Clarification Question”.

FIG. 4 is a diagram that illustrates example operations for intent discovery, used with establishing a knowledge set used in a virtual agent. As shown, a chat log 410 provides input data to an intent discovery process 420. The chat log 410 may include a set of chat session transcripts from hundreds, thousands, or more, of chat sessions, between humans, or between a human and virtual agent. The intent discovery process 420 uses a classification technique, such as with a machine learning model, to produce a set of candidate intents 430.

The set of candidate intents 430 is provided for approval by a group of human users 440, such as for approval by an administrator, editor, or other content curator. The approved intents from the set of candidate intents 460 are then associated with trigger phrases 450, and relevant conversation content 470. For example, the trigger phrases 450 may include various queries, keywords, questions, prompts, or statements used to invoke a particular intent (e.g., “I need help with unlocking my computer”; or “How can I open my computer?”); the relevant conversation content 470 may include various questions, answers, clarification questions, clarification answers, solutions, or other content, provided as part of the conversation to address the particular intent.

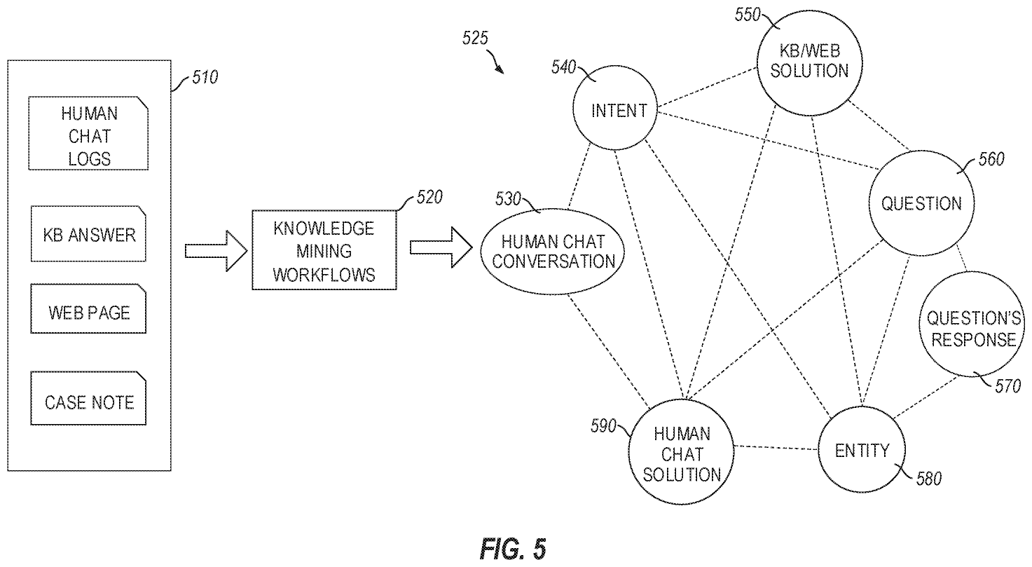

FIG. 5 is a diagram that illustrates example operations for building a knowledge graph, used with establishing a knowledge set in a virtual agent. As shown, a set of unstructured data 510 includes knowledge base answers, web page content, and case notes, in addition to human chat logs. This unstructured data 510 is provided to knowledge mining workflows 520, such as implemented by offline processing that uses a machine learning model to create a conversation model, as discussed above. The knowledge mining workflows 520 are used to create a knowledge graph 525 which establishes relationships among intents, conversations, and conversation properties, identified from the unstructured data.

As shown, the knowledge graph 525 relates properties of a human chat conversation 530 to an intent 540, knowledge base/web page solution information 550, a question 560, a question response 570, an entity 580, and a chat solution 590. The knowledge graph 525 may establish such relationships for each conversation instance; in further examples, a conversation 530 may be linked to multiple of the conversation properties (e.g., multiple intents, multiple solutions, etc.).

As a simple example of the relationships created within the knowledge graph 525, consider a human chat conversation 530 deployed for technical support of a product, for an entity 580 representing the product. This conversation 530 is linked in the knowledge graph 525 to an intent 540 such as to identify a particular problem (e.g., unable to use product), with a series of questions 560 and question responses 570. Upon identifying the intent 540 from use of the questions 560 and responses 570, used to narrow a diagnosis from among the possible solution information 550, a human chat solution 590 is offered in the conversation 530 to present instructions to resolve the problem. It will be understood that different conversations or changed conversations may be deployed depending on the responses occurring in the conversation, such as in cases where a conversation leads to another identified intent 540, which then leads to an entirely different set of questions, responses, and solutions from the knowledge graph 525.

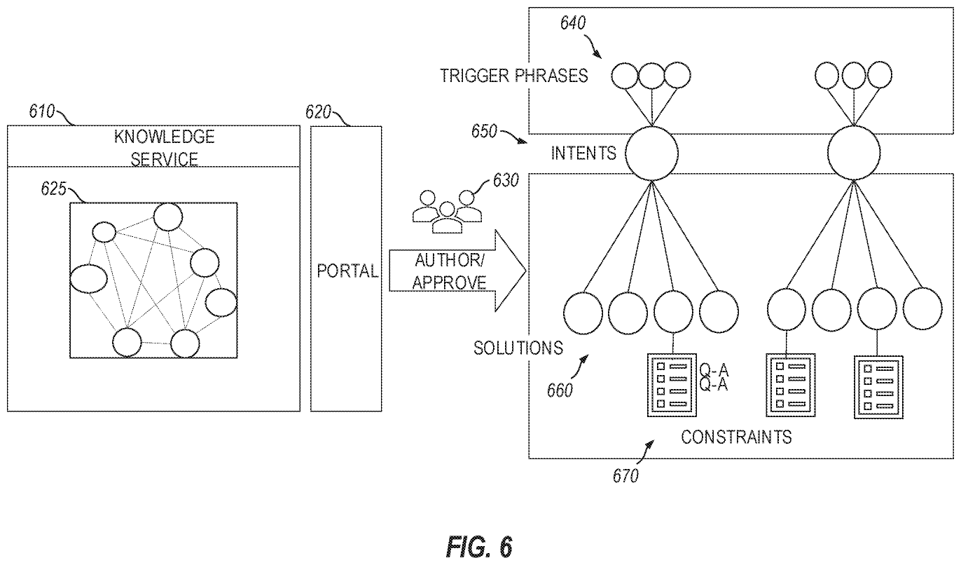

FIG. 6 is a diagram that illustrates example operations for use of an authoring solution, used with establishing conversations of a virtual agent from a knowledge service 610. This knowledge service 610 may operate as a component or system responsible for understanding and querying the knowledge graph based on current authoring requirements and context. As shown, the knowledge service 610 is linked to a portal 620 to enable the creation, population, and approval of knowledge graph data 625 corresponding to multiple knowledge information items.

In a similar manner as in FIG. 4, a group of human users 630, such as an administrator, editor, or other content curator, uses the portal 620 to create, edit, and approve the content. Specifically, the human users 630 may create, edit, and refine suggested trigger phrases 640 that are tied to approved intents 650; the human users 630 may create, edit, and refine suggested solutions 660, and constraints 670 tied to such solutions. For instance, the constraints 670 may provide specific restrictions, conditions, or qualifications on the particular questions, question responses, and answers used in a conversation workflow.

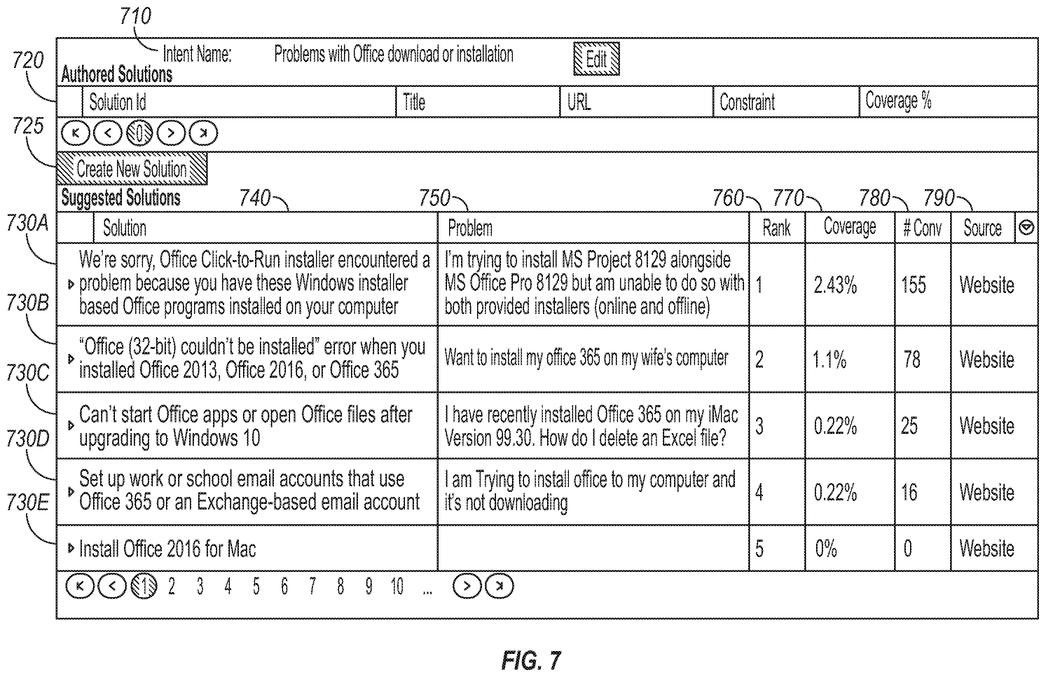

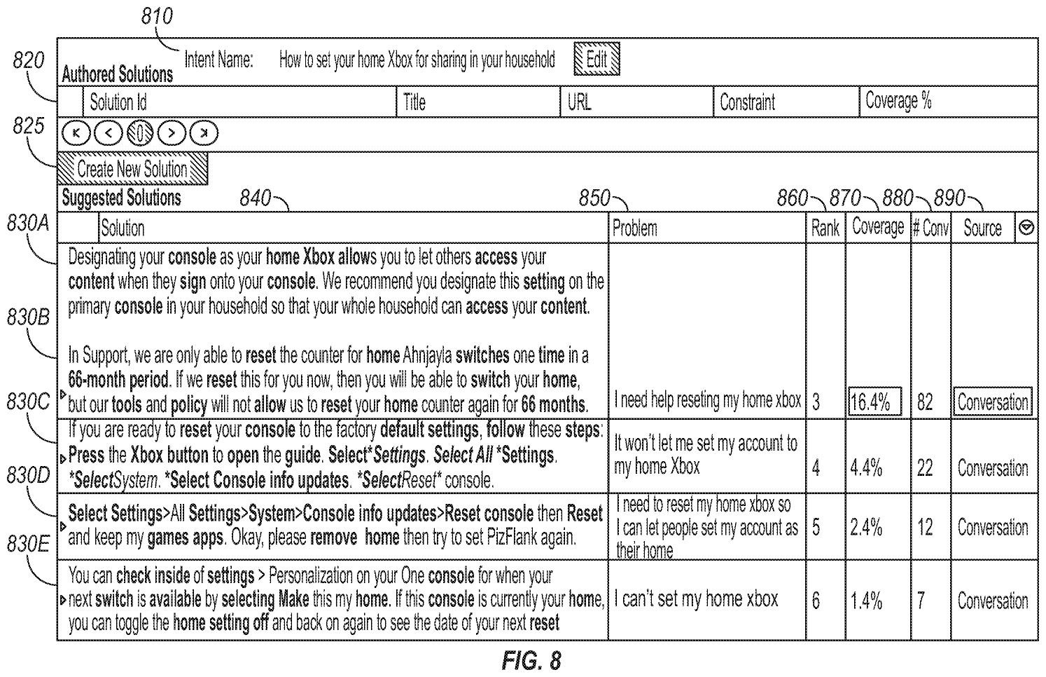

FIGS. 7 and 8 depict graphical user interfaces that illustrate example suggested solutions generated with the automated authoring techniques discussed herein. As shown, the user interface of FIG. 7 specifically depicts a layout in which a particular identified intent 710 (a technical support intent, “Problems with Office download or installation”) is linked to a set of authored solutions 720 and suggested solutions 730 from a predefined knowledge base. The results of the automated authoring techniques, automatically mined from an unstructured knowledge set, are shown in the form of suggested solutions 730A, 730B, 730C, 730D, 730E. Other functionality to create a new solution 725 and access or navigate through the previously authored solutions 720 or the suggested solutions 730 may also be provided in the user interface.

Each of the solutions 730A-730E is further shown as having characteristics including a solution characteristic 740, a problem characteristic 750, a rank value 760, a coverage value 770, a number of linked conversations 780, and a source indication 790. As shown, each particular solution includes the solution characteristic 740 in the form of extracted text which indicates an exemplary description of the problem, and the problem characteristic 750 in the form of extracted text which indicates an exemplary description of the solution. Further, the source indication 790 indicates that the source of the data for a particular suggested solution is from website text (e.g., from a support forum); the number of linked conversations 780 indicates how many conversations are related to the particular suggested solution; the coverage value 770 indicates what percentage of the analyzed conversations are linked to the particular suggested solution; and the rank value 760 shows a ranking of this percentage.

Likewise, the user interface of FIG. 8 depicts a layout in which a set of suggested solutions 830A, 830B, 830C, 830D, 830E are extracted from an unstructured conversation source. Here, the particular identified intent (a technical support intent, “How to set your home Xbox for sharing in your household”) may be linked to a set of previously authored solutions 820 (empty) and the suggested solutions 830 (five suggested solutions). Each of the suggested solutions 830A-830E is further shown as having characteristics including a solution characteristic 840, a problem characteristic 850, a rank value 860, a coverage value 870, a number of linked conversations 880, and a source indication 890, in this case derived from a prior human conversation. Notably, suggested solutions 830A, 830B relate to the same problem, and thus are grouped together. Other functionality to create a new solution 825 and access or navigate through the previously authored solutions 820 or the suggested solutions 830 may also be provided in the user interface.

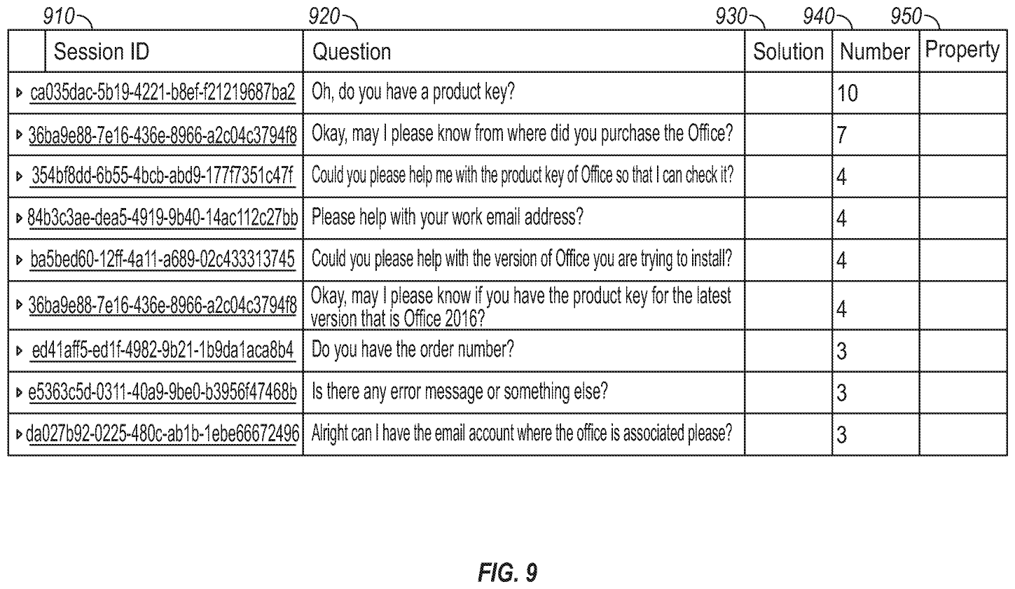

FIG. 9 depicts a graphical user interface that illustrates example suggested questions generated with the automated authoring techniques discussed herein. For instance, based on the solution authoring techniques performed by an administrator, such as with the interfaces depicted in FIGS. 7 and 8, a set of suggested questions can be identified from various historical or ongoing sessions and results.

As shown, the user interface of FIG. 9 illustrates how various user sessions 910 can be tied to suggested questions 920. For instance, a common set of questions can be suggested based on correspondence to a particular suggested solution 930, a number of instances 940 (frequency), or suggested properties 950. This user interface also shows how suggested and ranked questions for the current intent and solution may be authored based on the support knowledge graph. Finally, the presentation of the suggested solutions 930 and suggested properties 950 also may easily show a user whether a question group has already been authored for an existing solution or property.

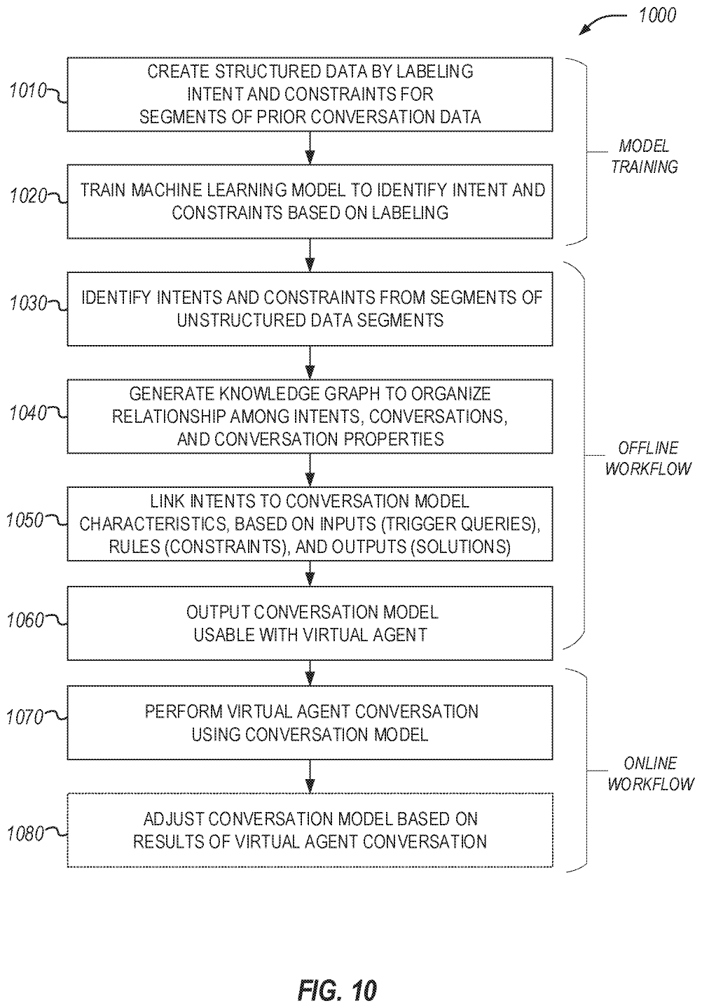

FIG. 10 is a flowchart 1000 of an example method for automated authoring, to produce a conversation model for automated agent deployments as discussed herein. It will be understood that the operations of the flowchart 1000 may be implemented in connection with a computer-implemented method, instructions on a computer program product, or with a configuration of a computing device (or among multiple of such methods, products, or computing devices). In an example, the electronic operations are performed by a computing device that includes at least one processor to perform electronic operations to implement the method. However, other variation in software and hardware implementations may also initiate, control, or accomplish the method.

As shown, the operations of the flowchart 1000 include aspects of model training, including commencing at operation 1010 to create structured data by labeling intent and constraints for segments of prior conversation data, and continuing at operation 1020 to perform training of a machine learning model to identify intent and constraints based on the labeled prior conversation data. In a specific example, the machine learning model is trained from a set of structured learning data, with such data including various conversation content (e.g., utterance) types labeled as: a problem, a clarification question, a clarification answer, or a solution. Also in a specific example, the machine learning model is a CRF classifier, such that the CRF classifier is trained to classify the conversation content type (such as a respective type of utterance).

The operations of the flowchart 1000 continue to provide aspects of an offline workflow for generating a conversation model, including: identifying respective intents (and constraints, as applicable) from segments of unstructured data segments, in operation 1030; generating a knowledge graph of a conversation model, at operation 1040, to organize relationship among intents, conversations, and conversation properties; linking the respective intents in the knowledge graph to properties of the respective conversations, at operation 1050, based on inputs (e.g., trigger queries), rules (e.g., constraints), and outputs (e.g., solutions); and outputting the conversation model, at operation 1060, as the conversation model is provided to be usable with a virtual agent to conduct a subsequent conversation with a human user.

In a specific example, identifying the intents and constraints includes using the trained machine learning model to identify respective segments of the conversation data, as the machine learning model operates to identify the intent and a conversation content type from the respective segments of the conversation data. Also, in a specific example, the subsequent use of the knowledge graph in the conversation model directs the subject conversation based on an intent expressed in a subject conversation. Further, the properties of the respective conversations are designed to guide the subject conversation with the conversation model, based on properties such as trigger phrases, solutions, and constraints corresponding to the respective intents.

In further examples, the conversation segments are extracted from features of the unstructured data source, with features provided from one or more of: human-agent conversation transcripts, human-agent chat logs, human-authored knowledge base information, human-authored web page content, or human-authored documentation. In a specific example, the conversation model is adapted to provide output in the subject conversation based on a scored likelihood of a particular solution and a scored likelihood of a particular diagnosis, and based on inputs received in the subject conversation from the human user. Also in a specific example, the conversation model is adapted to provide a conversation workflow to identify a particular solution for the expressed intent based on the trigger phrases, such that the trigger phrases include a set of conversation queries used to invoke the expressed intent. Further, the particular solution may be associated with a set of conversation responses used to reply to the expressed intent, such that the constraints restrict applicability of the particular solution to a particular set of conditions indicated by the conversation workflow.

The operations of the flowchart 1000 conclude with operations of the online workflow, including the use of the conversation model to perform a virtual agent conversation with a human user in operation 1070. The operations of the flowchart 1000 may optionally conclude with adjustment of the conversation model, in operation 1080, based on results of the virtual agent conversation. For instance, if the conversation between the human user and the virtual agent results in an error condition, an unresolved state, or an incorrect state, modifications to the conversation model (or the machine learning model) may be implemented to prevent the error from occurring in subsequent conversations.

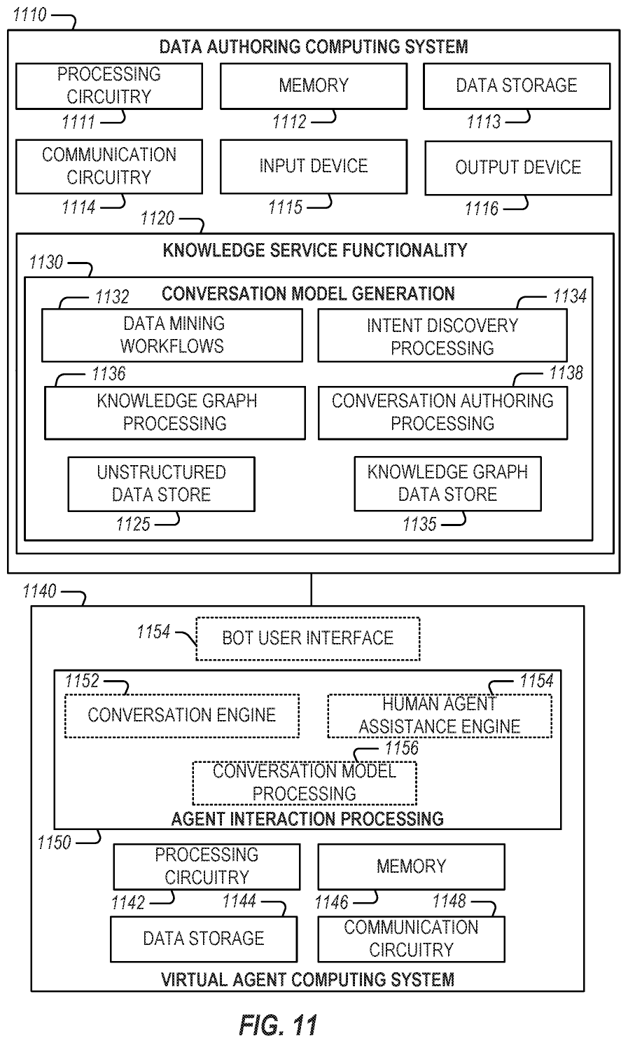

FIG. 11 illustrates a block diagram 1100 of hardware and functional components of a data authoring computing system 1110 and a virtual agent computing system 1140 to implement aspects of creation and use of a conversation model for automated agents, such as are accomplished with the examples described above. It will be understood, that although certain hardware and functional components are depicted in FIG. 11 and in other drawings as separate systems or components, the features of the components may be integrated into a single system or service (e.g., in a single computing platform providing offline and online processing workflows). Further, although only one data authoring computing system and one virtual agent computing system is configured, it will be understood that the features of these systems may be distributed among one or multiple computing systems, including in cloud-based processing settings.

As shown, the data authoring computing system 1110 includes processing circuitry 1111 (e.g., a CPU) and a memory 1112 (e.g., volatile or non-volatile memory) used to perform electronic operations (e.g., via instructions) to generate and train a conversation model (e.g., by implementing the offline conversation model training, identification, and optimization techniques depicted in FIGS. 1-10); data storage 1113 to store commands, instructions, and other data for generation and training of the conversation model; communication circuitry 1114 to communicate with an external network or devices via wired or wireless networking components for the conversation model operations; an input device 1115 (e.g., an alphanumeric, point-based, tactile, audio input device) to receive input from a human user for control or adaptation of the conversation model operations; and an output device 1116 (e.g., visual, acoustic, haptic output device) to provide output to the human user relating to the conversation model operations or implementation in a knowledge service.

In an example, the data authoring computing system 1110 is adapted to perform conversation model generation 1130, within an knowledge service platform 1120 (e.g., implemented by circuitry or software instructions), such as through: data mining workflows 1132 used to identify intents and constraints from conversations of unstructured data (e.g., from unstructured data store 1125); intent discovery processing 1134 used to identify intents which provide topics for conversation workflows; knowledge graph processing 1136, used to generate a knowledge graph to organize the identified intents, and link the respective intents in the knowledge graph to properties of the respective conversations; and conversation authoring processing 1138, used to generate aspects of a conversation model that presents aspects of questions, answers, responses, and other content. The conversation model generation 1130 may perform these functions through the use of the unstructured data store 1125 and the knowledge graph data store 1135. Although FIG. 11 depicts the execution of the components 1130, 1132, 1134, 1136, 1138 within the same computing system 1110, it will be understood that these components may be executed on other computing systems, including multiple computing systems as orchestrated in a server-based (e.g., cloud) deployment.

As shown, the virtual agent computing system 1140 includes processing circuitry 1143 (e.g., a CPU) and a memory 1145 (e.g., volatile or non-volatile memory) used to perform electronic operations (e.g., via instructions) for hosting and deploying a conversation model in a virtual agent setting, such as with the conversation model generated by the generation functionality 1130 (e.g., in connection with the offline conversation model processing discussed with reference to FIGS. 1-10). The virtual agent computing system 1140 further includes data storage 1144 to store commands, instructions, and other data for the virtual agent operations; and communication circuitry 1146 to communicate with an external network or devices via wired or wireless networking components for the virtual agent communication engine.

In an example, the virtual agent computing system 1140 includes a bot user interface 1160 (e.g., an audio, text, graphical, or virtual reality interface, etc.) that is adapted to expose the features of the virtual agent to a human user, and to facilitate the conversation from a trained conversation model (e.g., as produced by the generation functionality 1130). The operation of the bot user interface may be controlled by agent interaction processing functionality 1150 (e.g., implemented with a combination of circuitry and software instructions), which includes: a conversation engine 1152 designed to use and expose the conversation model in a conversation workflow; a human agent assistance engine 1154 adapted to interpret instructions commands as part of a support workflow; and conversation model processing 1156 adapted to perform conversations with a human user in the conversation workflow, while consuming the conversation model and the applicable content from the knowledge graph. Other variations to the roles and operations performed by the virtual agent computing system 1140 and the data authoring computing system 1110 may also implement the conversation workflow and model authoring and use techniques discussed herein.

As referenced above, the embodiments of the presently described electronic operations may be provided in machine or device (e.g., apparatus), method (e.g., process), or computer- or machine-readable medium (e.g., article of manufacture or apparatus) forms. For example, embodiments may be implemented as instructions stored on a machine-readable storage medium, which may be read and executed by a processor to perform the operations described herein. A machine-readable medium may include any non-transitory mechanism for storing information in a form readable by a machine (e.g., a computer). A machine-readable medium may include a single medium or multiple media (e.g., a centralized or distributed database, and/or associated caches and servers) that store the one or more instructions.

A machine-readable medium may include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. A machine-readable medium shall be understood to include, but not be limited to, solid-state memories, optical and magnetic media, and other forms of storage devices. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and optical disks. The instructions may further be transmitted or received over a communications network using a transmission medium (e.g., via a network interface device utilizing any one of a number of transfer protocols).

Although the present examples refer to various forms of cloud services and infrastructure service networks, it will be understood that may respective services, systems, and devices may be communicatively coupled via various types of communication networks. Examples of communication networks include a local area network (LAN), a wide area network (WAN), the Internet, mobile telephone networks, plain old telephone (POTS) networks, and wireless data networks (e.g., Wi-Fi, 2G/3G, 4G LTE/LTE-A, 5G, or other personal area, local area, or wide area networks).

Embodiments used to facilitate and perform the electronic operations described herein may be implemented in one or a combination of hardware, firmware, and software. The functional units or capabilities described in this specification may have been referred to or labeled as components, processing functions, or modules, in order to more particularly emphasize their implementation independence. Such components may be embodied by any number of software or hardware forms. For example, a component or module may be implemented as a hardware circuit comprising custom circuitry or off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. The executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as the command and control service) may take place on a different processing system (e.g., in a computer in a cloud-hosted data center), than that in which the code is deployed (e.g., in a test computing environment). Similarly, operational data may be included within respective components or modules, and may be embodied in any suitable form and organized within any suitable type of data structure. The operational data may be collected as a single data set, or may be distributed over different locations including over different storage devices.

In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. A computing device, comprising:
a processor; and
a memory device including instructions embodied thereon, wherein the instructions, when executed by the processor, cause the processor to perform operations to produce a conversation model for use with an automated agent, the operations comprising:
identifying respective intents from conversation segments in an unstructured data source;
generating a knowledge graph of the conversation model to organize the identified intents, the knowledge graph structured to associate respective conversations with the respective intents;
linking the respective intents in the knowledge graph to properties of the respective conversations, the properties used to guide a subject conversation with the conversation model, wherein the properties include trigger phrases, solutions, and constraints corresponding to the respective intents; and
outputting the conversation model, the conversation model usable with the automated agent to conduct the subject conversation with a human user, wherein subsequent use of the knowledge graph by the conversation model directs the subject conversation based on an intent expressed in the subject conversation.

2. The computing device of claim 1, the operations further comprising:
extracting the conversation segments from the unstructured data source, wherein the conversation segments are extracted from one or more of: human-agent voice conversation transcripts, human-agent text chat logs, human-authored knowledge base information, human-authored web page content, or human-authored documentation.

3. The computing device of claim 1, wherein the conversation model is adapted to provide output in the subject conversation based on a scored likelihood of a particular solution and a scored likelihood of a particular diagnosis, based on inputs received in the subject conversation from the human user.

4. The computing device of claim 1, wherein the conversation model is adapted to provide a conversation workflow to identify a particular solution for the expressed intent based on the trigger phrases, wherein the trigger phrases include a set of conversation queries used to invoke the expressed intent, wherein the particular solution is associated with a set of conversation responses used to reply to the expressed intent, and wherein the constraints restrict applicability of the particular solution to a particular set of conditions indicated by the conversation workflow.

5. The computing device of claim 1, wherein the operations are performed in an offline processing workflow, and wherein the conversation model is provided for use in an online processing workflow in a conversation engine of an automated chat bot.

6. The computing device of claim 1, wherein the unstructured data source includes conversation data, and wherein identifying intents for the conversation data is performed with operations comprising:
applying a machine learning model to respective segments of the conversation data, the machine learning model adapted to identify the intent and a conversation content type from the respective segments of the conversation data.

7. The computing device of claim 6, wherein the machine learning model is trained from a set of structured learning data, wherein the conversation content type includes an utterance type identified as a: problem, clarification question, clarification answer, or a solution.

8. The computing device of claim 6, wherein the machine learning model is a conditional random field (CRF) classifier, wherein the CRF classifier is used to classify the respective utterance types.

9. The computing device of claim 1, wherein the conversation model is adapted to conduct the subject conversation in a technical support scenario with the human user, wherein the intent expressed in the subject conversation relates to one or more support issues in the technical support scenario, wherein the solutions relate to one or more support solutions in the technical support scenario, and wherein the constraints relate to properties of a product or service involved with the support issues.

10. The computing device of claim 9, wherein the constraints relate to a plurality of properties for a product, relating to one or more of: a product instance, a product type, a product version, a product release, a product feature, or a product use case.

11. A non-transitory machine-readable storage medium, the machine-readable storage medium including instructions that, when executed by a processor and memory of a machine, causes the machine to perform operations to produce a conversation model for use with automated agents, the operations comprising:
identifying respective intents from conversation segments in an unstructured data source;
generating a knowledge graph of the conversation model to organize the identified intents, the knowledge graph structured to associate respective conversations with the respective intents;
linking the respective intents in the knowledge graph to properties of the respective conversations, the properties used to guide a subject conversation with the conversation model, wherein the properties include trigger phrases, solutions, and constraints corresponding to the respective intents; and
outputting the conversation model, the conversation model usable with an automated agent to conduct the subject conversation with a human user, wherein subsequent use of the knowledge graph by the conversation model directs the subject conversation based on an intent expressed in the subject conversation.

12. The machine-readable storage medium of claim 11, the operations further comprising:
extracting the conversation segments from the unstructured data source, wherein the conversation segments are extracted from one or more of: human-agent conversation transcripts, human-agent chat logs, human-authored knowledge base information, human-authored web page content, or human-authored documentation.

13. The machine-readable storage medium of claim 11, wherein the conversation model is adapted to provide output in the subject conversation based on a scored likelihood of a particular solution and a scored likelihood of a particular diagnosis, based on inputs received in the subject conversation from the human user.

14. The machine-readable storage medium of claim 11, wherein the conversation model is adapted to provide a conversation workflow to identify a particular solution for the expressed intent based on the trigger phrases, wherein the trigger phrases include a set of conversation queries used to invoke the expressed intent, wherein the particular solution is associated with a set of conversation responses used to reply to the expressed intent, and wherein the constraints restrict applicability of the particular solution to a particular set of conditions indicated by the conversation workflow.

15. The machine-readable storage medium of claim 11, wherein the unstructured data source includes conversation data, and wherein identifying intents for the conversation data is performed with operations comprising:
applying a machine learning model to respective segments of the conversation data, the machine learning model adapted to identify the intent and a conversation content type from the respective segments of the conversation data.

16. A method to produce a conversation model for use with automated agents, comprising a plurality of operations executed with a processor and memory of a computing device, the plurality of operations comprising:
identifying respective intents from conversation segments in an unstructured data source;
generating a knowledge graph of the conversation model to organize the identified intents, the knowledge graph structured to associate respective conversations with the respective intents;
linking the respective intents in the knowledge graph to properties of the respective conversations, the properties used to guide a subject conversation with the conversation model, wherein the properties include trigger phrases, solutions, and constraints corresponding to the respective intents; and
outputting the conversation model, the conversation model usable with an automated agent to conduct the subject conversation with a human user, wherein subsequent use of the knowledge graph by the conversation model directs the subject conversation based on an intent expressed in the subject conversation.

17. The method of claim 16, the operations further comprising:
extracting the conversation segments from the unstructured data source, wherein the conversation segments are extracted from one or more of: human-agent conversation transcripts, human-agent chat logs, human-authored knowledge base information, human-authored web page content, or human-authored documentation.

18. The method of claim 16, wherein the conversation model is adapted to provide output in the subject conversation based on a scored likelihood of a particular solution and a scored likelihood of a particular diagnosis, based on inputs received in the subject conversation from the human user.

19. The method of claim 16, wherein the conversation model is adapted to provide a conversation workflow to identify a particular solution for the expressed intent based on the trigger phrases, wherein the trigger phrases include a set of conversation queries used to invoke the expressed intent, wherein the particular solution is associated with a set of conversation responses used to reply to the expressed intent, and wherein the constraints restrict applicability of the particular solution to a particular set of conditions indicated by the conversation workflow.

20. The method of claim 16, wherein the unstructured data source includes conversation data, and wherein identifying intents for the conversation data is performed with operations comprising:
applying a machine learning model to respective segments of the conversation data, the machine learning model adapted to identify the intent and a conversation content type from the respective segments of the conversation data.
